(19) United States
(12) Patent Application Publication
(10) Pub. No.: US 2007/0294620 A1
(43) Pub. Date: Dec. 20, 2007

(54) Apparatus and method for displaying java application in portable terminal

(75) Inventors: Jae-Min Lee, Seoul (KR); Ki-Bong Choi, Anyang-si (KR); Ji-Hyun Kim, Incheon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd.

(21) Appl. No.: 11/803,645

(22) Filed: May 15, 2007

(30) Foreign Application Priority Data
Jun. 16, 2006 (KR) 2006/0054128

(51) Int. Cl. G06F 3/048

(52) U.S. Cl. 715/706

(57) ABSTRACT

An apparatus and method for displaying a Java application in a portable terminal. In the apparatus, a category searcher searches a category of the Java application and a corresponding category icon, a Java processor controls a displaying of the searched category icon when the Java application is executed, and a display displays the searched category icon under control of the Java processor.

### PRIORITY

This application claims priority under 35 U.S.C. § 119 to an application filed in the Korean Intellectual Property Office on Jun. 16, 2006 and allocated Ser. No. 2006-54128, the contents of which are incorporated herein by reference.

### BACKGROUND OF THE INVENTION

1. Field of the Invention

The present invention generally relates to an apparatus and method for displaying a Java application in a portable terminal, and in particular, to an apparatus and method for displaying a Java application in a portable terminal, in which different icons are displayed depending on a category and rate of Java application that is being executed.

2. Description of the Related Art

In recent years, portable terminals, such as mobile communication terminals, Personal Digital Assistants (PDAs), etc., have been widely used and their application range is increasing. Portable terminals can provide various functions including, for example, a phone call function, a scheduling function, an image photographing function using a built-in digital camera, a movie playing function, a digital broadcasting service, a document editing function, and a game function.

In addition, portable terminals can provide various functions to users by downloading and executing Java applications. Java applications are examples of software applications. Examples of Java applications executed in portable terminals are comic, music, game, etc.

FIGS. 1A and 1B show a displayed image of a Java application when it is executed in a portable terminal. Specifically, FIG. 1A shows a displayed image when the Java application is being executed. A Java application execution icon 102 indicates that the Java application is being executed. The Java application execution icon 102 is displayed in color. FIG. 1B shows a displayed image when the Java application is in a Java pause state. A Java application pause icon 112 indicates that the Java application is in a Java pause state. The Java application pause icon 112 is displayed in black and white.

As shown in FIGS. 1A and 1B, a portable terminal uses the icons to indicate the Java execution state and the Java pause state. However, the icons distinguish the Java execution state from the Java pause state, but cannot distinguish a category and rate of the Java application.

Table 1 below shows attributes included in a Java Application Descriptor (JAD) file of the Java application. The attributes comply with the Mobile Information Device Protocol (MIDP) 2.0 specification of Java Specification Request 118.

TABLE 1

| Attribute name | Attribute value |
|---|---|
| MIDlet-Name | The name of the MIDlet suite that identifies |
| | the MIDlets to the user. |
| MIDlet-Version | The version number of the MIDlet suite. |
| MIDlet-Vendor | The organization that provides the MIDlet |
| | suite. |
| MIDlet-Jar-URL | The Uniform Resource Locator (URL) from |
| | which the Java ARchive (JAR) file can be |
| | loaded. |
| MIDlet-Jar-Size | The number of bytes in the JAR file. |
| MicroEdition-Profile | The Java 2 Micro Edition (J2ME) profiles, |
| | using the same format and value as the |
| | System property microedition.profiles |
| | (for example “MIDP-2.0”). |

Referring to Table 1, a conventional Java application does not have an attribute that can distinguish its category and rate. Therefore, when a Java application is paused during its execution due to an incoming call, alarm or user's circumstances, it is difficult to detect what kind of Java application was being executed.

Meanwhile, a conventional portable terminal executes Java applications one by one, and a Multi-tasking Virtual Machine (MVM) that can simultaneously execute more than one Java application is being developed. If more than one Java application being simultaneously executed is displayed with a single icon, the user cannot distinguish the category and rate of the executed Java application.

### SUMMARY OF THE INVENTION

An object of the present invention is to substantially solve at least the above problems and/or disadvantages and to provide at least the advantages below. Accordingly, an object of the present invention is to provide an apparatus and method for displaying a Java application in a portable terminal.

Another object of the present invention is to provide an apparatus and method for displaying an icon corresponding to a category of a Java application that is being executed in a portable application.

A further object of the present invention is to provide an apparatus and method for displaying an icon corresponding to a rate of a Java application that is being executed in a portable terminal.

According to one aspect of the present invention, an apparatus for displaying a Java application in a portable terminal includes a category searcher for searching a category of the Java application and a corresponding category icon, a Java processor for controlling a displaying of the searched category icon when the Java application is executed, and a display for displaying the searched category icon under control of the Java processor.

According to another aspect of the present invention, an apparatus for displaying a Java application in a portable terminal includes a rate searcher for searching a rate of the Java application and a corresponding rate icon, a Java processor for controlling a displaying of the searched rate icon when the Java application is executed, and a display for displaying the searched rate icon under control of the Java processor.

According to a further aspect of the present invention, a method for displaying a Java application in a portable terminal includes searching a category of the Java application and a corresponding category icon when the Java application is executed, and displaying the searched category icon on a display.

According to a further aspect of the present invention, a method for displaying a Java application in a portable terminal includes searching a rate of the Java application and a corresponding rate icon when the Java application is executed, and displaying the searched rate icon on a display.

### BRIEF DESCRIPTION OF THE DRAWINGS

The above and other objects, features and advantages of the present invention will become more apparent from the following detailed description when taken in conjunction with the accompanying drawings in which:

FIGS. 1A and 1B illustrate a displayed image of a Java application according to the related art;

FIG. 2 is a block diagram of an apparatus for displaying a Java application in a portable terminal according to the present invention;

FIG. 3 is a flowchart illustrating a method for displaying an icon corresponding to a category and rate of a Java application in a portable terminal according to the present invention;

FIGS. 4A and 4B illustrate a displayed image of an icon corresponding to a category of a Java application in a portable terminal according to the present invention; and

FIGS. 5A and 5B illustrate a displayed image of an icon corresponding to a rate of a Java application in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, an apparatus and method for displaying a Java application in a portable terminal will be described. A Java application is one example of software applications.

Specifically, when a Java application is executed, an icon is differently displayed depending on a category and rate of the Java application, so the Java application is distinguished.

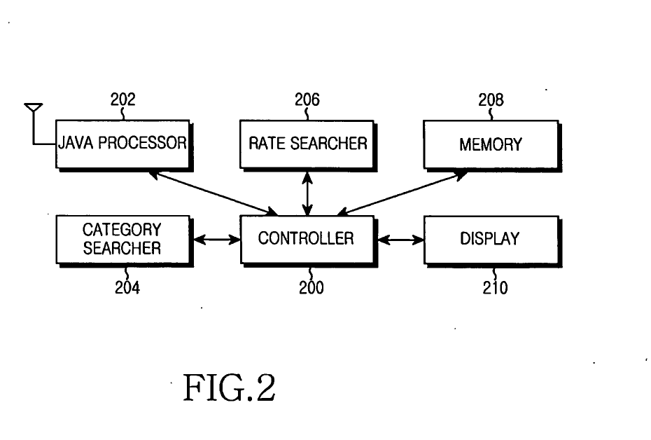

FIG. 2 shows an apparatus for displaying a Java application in a portable terminal according to the present invention. The portable terminal includes a controller 200, a Java processor 202, a category searcher 204, a rate searcher 206, a memory 206, and a display 210.

The Java processor 202 downloads a Java application and stores the downloaded Java application in the memory 208. Upon receipt of a Java application execution request and a Java application pause request, the Java processor 202 searches a category icon from the category searcher 204 and a rate icon from the rate searcher 206. The icons are displayed in color during the Java execution state, but in black and white during the Java pause state. Moreover, the icons can be partially displayed according to the category and rate of the Java application.

During the execution of the Java application, the category searcher 204 searches the category of the Java application and the corresponding category icon from a JAD file. The searched category icon is provided to the Java processor 202.

During the execution of the Java application, the rate searcher 206 searches the rate of the Java application and the corresponding rate icon from the JAD file. The searched rate icon is provided to the Java processor 202.

The JAD file includes attributes defined in Table 2 as well as the attributes defined in Table 1.

TABLE 2

| Attribute name | Attribute value |
|---|---|
| MIDlet-Category | The value defining the category of the Java |
| | application. |
| MIDlet-Category-Icon | The location of the category icon of the Java |
| | application. |
| MIDlet-Rate | The value defining the rate of the Java |
| | application. |
| MIDlet-Rate-Icon | The location of the rate icon of the Java |
| | application. |

Referring to Table 2, “MIDlet-Category” is a value defining the category of the Java application, for example, game, comic, music, etc. “MIDlet-Rate” is a value defining the rate of the Java application, for example, adult, junior, child, etc.

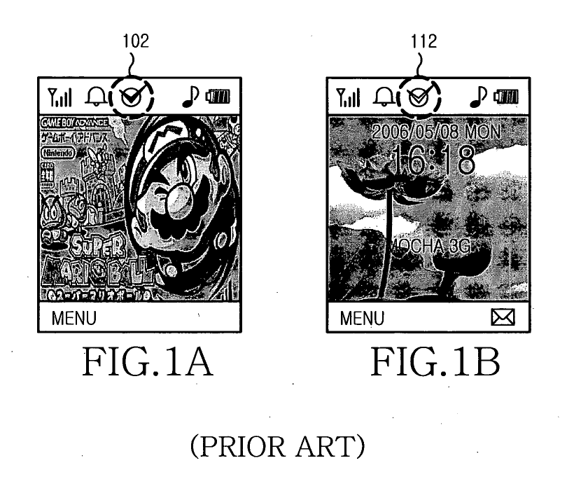

The controller 200 controls the Java processor 202, the category searcher 204, and the rate searcher 206. That is, the controller 200 can perform the functions of the Java processor 202, the category searcher 204, and the rate searcher 206. The separate implementation in FIG. 1 is merely for convenience of explanation. That is, in the real implementation, the controller 200 can be designed to perform some of the functions of these elements.

The memory 208 temporarily stores a control program of the portable terminal and data generated during operations, and also stores system parameters and backup data (e.g., telephone numbers, Short Message Service (SMS) messages, image data, etc.). In addition, the memory 208 stores the Java applications having icons corresponding to the execution/non-execution, the category, and the rate.

The display 210 outputs the icons corresponding to the execution/non-execution, the category, and the rate under control of the controller 200. A color liquid crystal display (LCD) can be used as the display 210.

A method for displaying a Java application in the portable terminal according to the present invention will be described below.

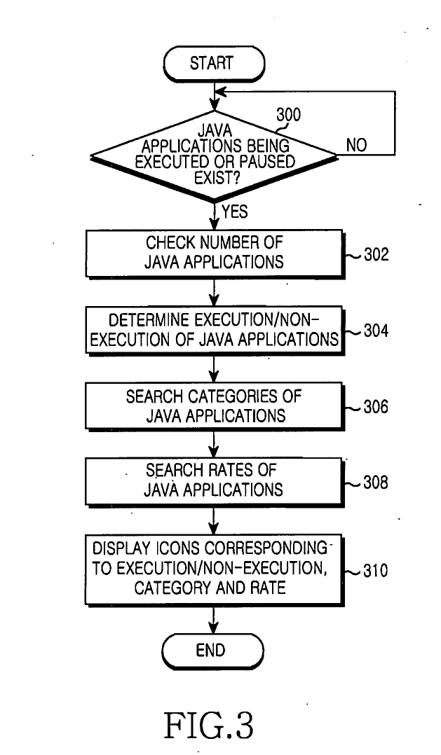

FIG. 3 shows a method for displaying an icon corresponding to a category and rate of a Java application in a portable terminal according to the present invention. The controller 200 determines in step 300 if there exist Java applications that are being executed or paused. In step 302, when there exist Java applications that are being executed or paused, the controller 200 checks the number of the corresponding Java applications. In step 304, the controller 200 determines if the respective Java applications are executed. In step 306, the controller 200 searches the categories of the Java applications. In step 308, the controller 200 searches the rates of the Java applications. In step 310, the controller 200 displays icons corresponding to the execution/non-execution, the category, and the rate.

Then, the controller 200 terminates the process.

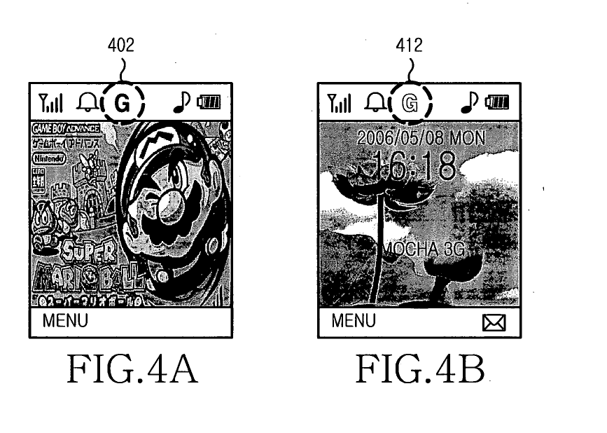

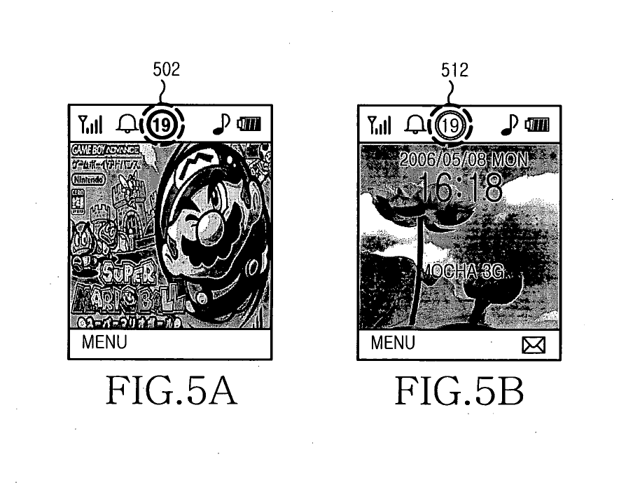

The displayed icons according to the execution/non-execution, the category, and the rate will be described below with reference to FIGS. 4A and 4B, and FIGS. 5A and 5B. FIGS. 4A and 4B show a displayed image of the icon corresponding to the category of the Java application in the portable terminal according to the present invention.

Specifically, FIG. 4A shows a displayed image when the executed Java application is categorized as a game. A Java application execution icon 402 indicates that the category of the Java application is a game, and is displayed in color in order to indicate that the Java application is being executed. FIG. 4B shows a displayed image when the Java application is in a Java pause state. A Java application pause icon 412 indicates that the category of the Java application is a game, and is displayed in black and white in order to indicate that the Java application is paused.

FIGS. 5A and 5B show a displayed image of the icon corresponding to the rate of the Java application in the portable terminal according to the present invention. Specifically, FIG. 5A shows a displayed image when the Java application rated as “adult” is executed. A Java application execution icon 502 indicates that the rate of the Java application is “adult”, and is displayed in color in order to indicate that the Java application is being executed. FIG. 5B shows a displayed image when the Java application is in a Java pause state. A Java application pause icon 512 indicates that the rate of the Java application is “adult”, and is displayed in black and white in order to indicate that the Java application is paused.

As described above, when the Java application is executed, the portable terminal displays the icons corresponding to the category and rate of the Java application. Therefore, the user can easily identify the category and rate of the Java application through the displayed icons.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for displaying a Java application in a portable terminal, comprising:
a category searcher for searching a category of the Java application and a corresponding category icon;
a Java processor for controlling a displaying of the searched category icon when the Java application is executed; and
a display for displaying the searched category icon under control of the Java processor.

2. The apparatus of claim 1, wherein the category searcher searches the category and the category icon of the Java application from a Java Application Descriptor (JAD) file of the Java application, the JAD file including attributes of a following Table:

| Attribute name | Attribute value |
|---|---|
| MIDlet-Category | Value defining the category of the Java |
| | application |
| MIDlet-Category-Icon | Location of the icon corresponding to the |
| | category of the Java application |

3. The apparatus of claim 1, wherein the Java processor displays the category icon in color when the Java application is being executed, and displays the category icon in black and white when the Java application is paused.

4. The apparatus of claim 3, wherein when a plurality of Java applications are being executed or paused, the Java processor outputs category icons corresponding to the execution/non-execution and the category of the Java applications.

5. An apparatus for displaying a Java application in a portable terminal, comprising:
a rate searcher for searching a rate of the Java application and a corresponding rate icon;
a Java processor for controlling a displaying of the searched rate icon when the Java application is executed; and
a display for displaying the searched rate icon under control of the Java processor.

6. The apparatus of claim 5, wherein the rate searcher searches the rate and the rate icon of the Java application from a Java Application Descriptor (JAD) file of the Java application, the JAD file including attributes of a following Table:

| Attribute name | Attribute value |
|---|---|
| MIDlet-Rate | Value defining the rate of the Java |
| | application |
| MIDlet-rate-Icon | Location of the icon corresponding to the |
| | rate of the Java application |

7. The apparatus of claim 5, wherein the Java processor displays the rate icon in color when the Java application is being executed, and displays the rate icon in black and white when the Java application is paused.

8. The apparatus of claim 7, wherein when a plurality of Java applications are being executed or paused, the Java processor outputs rate icons corresponding to the execution/non-execution and category of the Java applications.

9. A method for displaying a Java application in a portable terminal, comprising the steps of:
searching a category of the Java application and a corresponding category icon when the Java application is executed; and
displaying the searched category icon on a display.

10. The method of claim 9, wherein the step of searching the category icon comprises searching the category and the category icon of the Java application from a Java Application Descriptor (JAD) file of the Java application, the JAD file including attributes of a following Table:

| Attribute name | Attribute value |
|---|---|
| MIDlet-Category | Value defining the category of the Java |
| | application |
| MIDlet-Category-Icon | Location of the icon corresponding to the |
| | category of the Java application |

11. The method of claim 9, wherein the category icon is displayed in color when the Java application is being executed, and is displayed in black and white when the Java application is paused.

12. The method of claim 11, further comprising displaying category icons corresponding to execution/non-execution and category of a plurality of Java applications that are being executed or paused.

13. A method for displaying a Java application in a portable terminal, comprising the steps of:
searching a rate of the Java application and a corresponding rate icon when the Java application is executed; and
displaying the searched rate icon on a display.

14. The method of claim 13, wherein the step of searching the rate icon comprises searching the rate and the rate icon of the Java application from a Java Application Descriptor (JAD) file of the Java application, the JAD file including attributes of a following Table:

| Attribute name | Attribute value |
|---|---|
| MIDlet-Rate | Value defining the rate of the Java |
| | application |
| MIDlet-Rate-Icon | Location of the icon corresponding to the |
| | rate of the Java application |

15. The method of claim 13, wherein the rate icon is displayed in color when the Java application is being executed, and is displayed in black and white when the Java application is paused.

16. The method of claim 15, further comprising displaying rate icons corresponding to execution/non-execution and rates of a plurality of Java applications that are being executed or paused.

17. An apparatus for displaying a software application in a portable terminal, comprising:
a category searcher for searching a category of the software application and a corresponding category icon;
a processor for controlling a displaying of the searched category icon when the software application is executed; and
a display for displaying the searched category icon under control of the processor.

18. An apparatus for displaying a software application in a portable terminal, comprising:
a rate searcher for searching a rate of the software application and a corresponding rate icon;
a processor for controlling a displaying of the searched rate icon when the software application is executed; and
a display for displaying the searched rate icon under control of the processor.

19. A method for displaying a software application in a portable terminal, comprising the steps of:
searching a category of the software application and a corresponding category icon when the software application is executed; and
displaying the searched category icon on a display.

20. A method for displaying a software application in a portable terminal, comprising the steps of:
searching a rate of the software application and a corresponding rate icon when the software application is executed; and
displaying the searched rate icon on a display.
